(19) United States
(12) Patent Application Publication
(10) Pub. No.: US 2004/0073950 A1
(43) Pub. Date: Apr. 15, 2004

(54) Method and apparatus for user-selective execution and recording of interactive audio/video components

(75) Inventors: Jingwei Tan, Shanghai (CN); Declan Patrick Kelly, Eindhoven (NL); Jun Shi, Shanghai (CN); Liang Gan, Shanghai (CN); Philip Steven Newton, Eindhoven (NL)

Correspondence Address: Thomas E. Kocovsky, Esq., FAY, SHARPE, FAGAN, MINNICH & McKEE, LLP, Seventh Floor, 1100 Superior Avenue, Cleveland, OH, 44114-2518, US

(73) Assignee: KONINKLIJKE PHILIPS ELECTRONICS N.V.

(21) Appl. No.: 10/271,111

(22) Filed: Oct. 15, 2002

(51) Int. Cl. H04N 11/04; H04N 11/02; H04N 7/12; H04N 7/16; H04N 7/173; H04N 7/20

(52) U.S. Cl. 725/135; 348/389.1; 348/388.1; 725/90; 725/120; 725/139; 725/72

(57) ABSTRACT

In a processing method performed by a digital television receiver (18), a transport stream (84) is received. Data packets of the transport stream (84) associated with a selected audio/video offering are selected and sorted (90) into an audio/video component (92) and at least one supplemental component (94, 96, 98). Component identifiers (102, 104, 106, 108) are assigned (100) to the audio/video component (92) and the at least one supplemental component (94, 96, 98). The component identifiers (102, 104, 106, 108) are displayed (124) to an associated user. One or more selections of components are received (126) to include in a performance of the offering. The selected components are performed (154, 156, 158).

### BACKGROUND OF THE INVENTION

The present invention relates to the communication and entertainment arts. It particularly relates to interactive broadcast television, and will be described with particular reference thereto. However, the invention will also find application in prerecorded audio/video players, interactive cable television, and the like.

In present digital television, a digitized audio/video signal (A/V signal) is fed into a transport stream as a stream of data packets. In the multimedia home platform (MHP) format, these packets are 188 bytes each, with each packet having header information including at least a component identification. Typically, broadcast digital television includes a plurality of transport streams carried by a plurality of frequency channels, and the transport stream of each frequency channel carries a plurality of movies, sports events, television programs, and the like using packet multiplexing. The broadcast is transmitted to a home or other end user via a satellite transmission link, open-air broadcast, a television cable, or the like.

At the user end, a receiver box receives the broadcast digital television signal, frequency demodulates a selected frequency channel to recover the transport stream, and selects those data packets from the transport stream that correspond to the movie, sports event, television program, or other offering which the user wants to view. The data packets are combined to reconstruct the digitized A/V signal, which is transmitted to a digital television or other suitable viewing device for viewing.

It has been recognized that digital television is readily adapted to provide interactive content, non-A/V information, or other supplemental content by multiplexing data packets containing the supplemental content into the transport stream, and by including a microprocessor and other suitable electronics in the receiver box to execute the supplemental content. For example, supplemental content for a sporting event may include player and team statistics along with a suitable user interfacing framework by which the end user can access the statistics, for example using a small statistics window or box that is superimposed on the video display. The MHP format includes a common application programming interface (API) which is Java-enabled to facilitate development of supplemental content including interactive content.

Although such supplemental content can benefit the end user, it is also contemplated to include supplemental content which may be undesirable to certain end users. For example, some users might find a superimposed statistics window or box distracting. Moreover, it is contemplated to include supplemental content in the form of control software that, for example, prevents the user from fast-forwarding or skipping commercials, or that actively superimposes a commercial box on the video display.

To avoid these undesirable supplemental programs, some digital television receivers allow the user to disable all supplemental content associated with a selected movie, television program, or so forth. However, in this approach the user gives up any beneficial aspects of the supplemental content.

The present invention contemplates an improved apparatus and method that overcomes the aforementioned limitations and others.

### SUMMARY OF THE INVENTION

According to one aspect of the invention, a digital television program processing method is provided. Packets of a selected digital television program are sorted into an audio/video component and at least one supplemental component. Component identifiers are assigned to the audio/video component and the at least one supplemental component. The component identifiers are displayed to an associated user. One or more selections of components to include in a performance of the offering are received. A selected operation is executed using the selected components.

According to another aspect of the invention, a digital television receiving apparatus is disclosed. A sorting means is provided for sorting packets of a selected digital television program into an audio/video component and at least one supplemental component. An assigning means is provided for assigning component identifiers to the audio/video component and the at least one supplemental component. A display means is provided for displaying the component identifiers to an associated user. A user input means is provided for receiving one or more selections of components to include in a performance of the offering. An execution means is provided for executing a selected operation using the selected components.

One advantage of the present invention resides in improved user control over recorded and performed audio/video offering content.

Another advantage of the present invention resides in improved user selectivity over which supplementary program components to execute or record.

Yet another advantage of the present invention resides in reduced storage space requirements for recording digital television audio/video offerings by selectively omitting unwanted components.

Numerous additional advantages and benefits of the present invention will become apparent to those of ordinary skill in the art upon reading the following detailed description of the preferred embodiment.

### BRIEF DESCRIPTION OF THE DRAWINGS

The invention may take form in various components and arrangements of components, and in various steps and arrangements of steps. The drawings are only for the purpose of illustrating preferred embodiments and are not to be construed as limiting the invention.

FIG. 1 shows an exemplary digital television broadcast system including selective audio/video offering component performance and recording capability.

FIG. 2 shows a method for selectively recovering one or more content components of a selected audio/video offering from a broadband digital satellite signal.

FIG. 3 shows a method for selectively accessing one or more content components of a recorded audio/video offering.

FIG. 4 shows a method for enabling a user to select which content components of an audio/video offering to include in a performance.

FIG. 5 shows a method for enabling a user to update selections of content components for inclusion in an ongoing audio/video offering performance.

FIG. 6 shows a method for enabling a user to select which content components of an audio/video offering to include in a recording thereof.

FIG. 7 shows a method for enabling a user to remove or delete selected content components of a recorded digital audio/video offering.

### DETAILED DESCRIPTION OF THE PREFERRED EMBODIMENTS

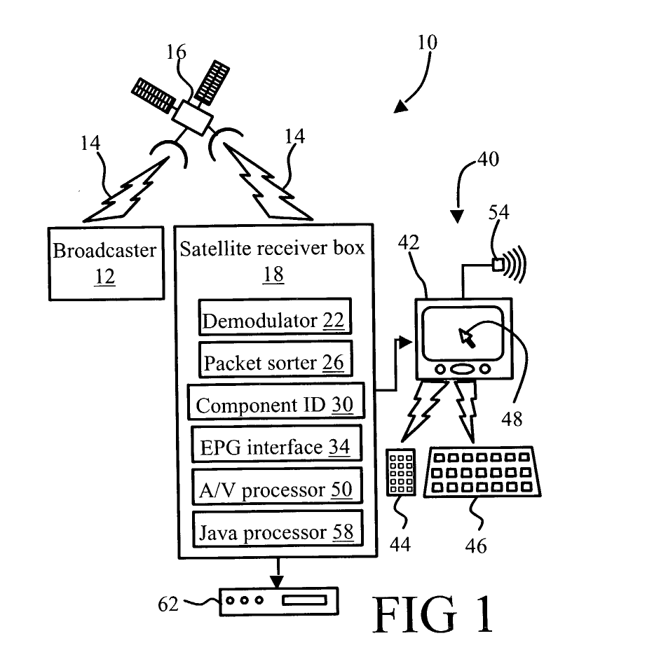

With reference to FIG. 1, a digital television broadcast system 10 includes a broadcasting station 12 that produces a frequency modulated digital television broadcast signal 14. The broadcast signal 14 typically includes a plurality of frequency channels over a designated band of frequencies, with each frequency channel carrying a transport stream including a plurality of television shows, programs, movies, or the like. At least some of the shows, programs, movies, etc. include associated supplemental content such as interactive programs, sports statistics, commercials, or the like.

Typically, the television shows, programs, movies, etc. are arranged in data packets, and the data packets of the various shows, programs, movies, etc. are multiplexed. Moreover, if a show includes supplemental content, packets corresponding to that content are advantageously multiplexed with the audio/video component. Such multiplexing advantageously permits viewing of the received portion of the show while simultaneously receiving packets corresponding to later time periods of the show, so that an end user need not wait for the entire show to be transmitted before viewing.

To provide extended broadcast range, the frequency modulated digital television broadcast signal 14 is optionally received and re-broadcast by one or more satellites 16. At a location of an end user, e.g. at a home, the television broadcast signal 14 is received by a satellite receiver box 18. The receiver box 18 includes a number of sub-components. A frequency demodulator 22 frequency demodulates a selected frequency of the broadcast signal 14 to recover the transport stream including the plurality of television shows, programs, movies, or the like.

A packet sorter 26 sorts the packets of the transport stream to extract packets of a selected audio/video offering such as a selected show, program, movie, or the like. If the selected audio/video offering includes supplemental content, the packet sorter 26 further sorts the selected audio/video offering into an audio/video component and one or more supplemental components.

A component identifier 30 identifies each component based on contents of a header packet of the component or of the audio/video offering, or based on a table of contents included in the transport stream. If the component identifier 30 is unable to determine a meaningful identifier from a header packet, table of contents, or other information source, the component is preferably identified by an index number, i.e. “supplemental component #1” or the like.

An electronic program guide (EPG) interface 34 cooperates with a user interface 40 to display an electronic program guide to an associated user. The user interface 40 includes a display device 42 such as an electron tube television, a flat-screen television, a computer monitor, or the like that under the direction of the electronic program guide interface 34 displays a list of audio/visual offerings of the transport stream based on the table of contents packet or packets contained therein.

The user selects one of the audio/visual offerings using an input device of the user interface 40. Suitable input devices include, for example, a hand-held television remote control 44, or a wireless computer keyboard 46. In a preferred point-and-click embodiment, the selections are made by controlling an on-screen pointer 48 using the input device 44, 46. If the user selects an audio/video offering that includes supplemental content, the electronic programming guide 34 cooperates with the display device 42 to display the components of the audio/video offering including the audio/video component and the one or more supplemental components. The user selects components using the input device 44, 46 to operate the on-screen pointer 48.

If an audio/video component is selected to be performed, an audio/video (A/V) processor 50 formats the audio/video component into streaming video that is displayed on the display device 42 and streaming audio that is played on a speaker 54, which is preferably a system of speakers with stereo capability. If a supplemental content component is selected to be performed, a Java processor 58 executes the supplemental content component to perform selected operations, which can include generation of visual content that is displayed on the display device 42, and/or generation of audio content that is played on the speaker 54. Instead of the Java processor 58, other microprocessor-based computational devices can be used.

Instead of or concurrently with performing the selected components of the selected audio/video offering, the user optionally saves the selected components including a selected none, some, or all of the supplemental content components to a non-volatile storage medium using a recording device 62. The recording device 62 preferably records on an optical disk which has read/write capability. However, other types of recording devices can also be employed, such as a magnetic or optical disk of a computer or a non-volatile electronic memory device. Preferably, the recording device 62 includes playback capability wherein a recorded audio/video offering is input to the receiver box 18 for selective performance on the user interface 40. If a combination of audio/video and supplemental content components is recorded, the plurality of components are suitably multiplexed to advantageously permits initiating viewing of the recorded audio/video offering while it is transmitted to the receiver box 18.

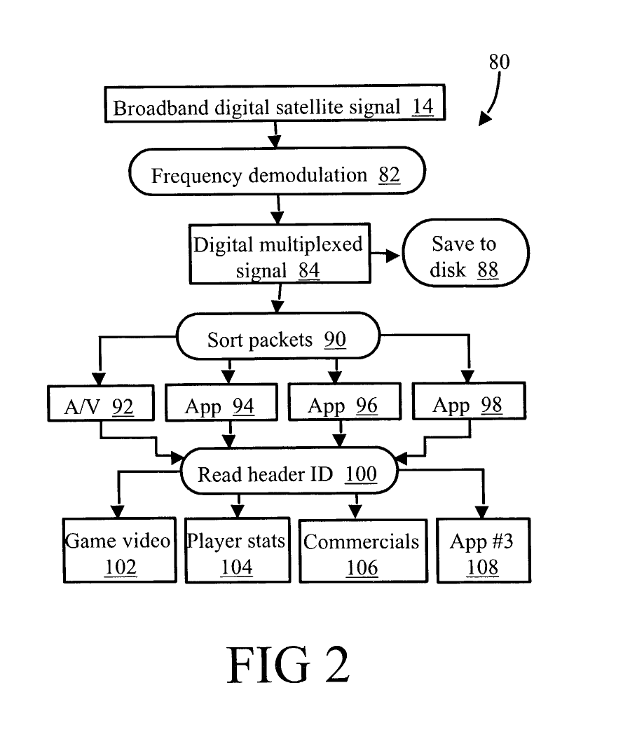

With continuing reference to FIG. 1 and with further reference to FIG. 2, a method 80 is performed by the satellite receiver box 18 to selectively recover one or more content components of a selected digital television show, program, movie, or other audio/video offering from the broadband digital satellite signal 14. The signal 14 is frequency demodulated in a step 82 to recover a selected frequency channel that contains the selected digital television audio/video offering. The demodulating step 82 is performed by the demodulator 22, and produces a digital multiplexed signal 84 or transport stream. Typically, the digital demodulator 22 includes a binary thresholding circuit that thresholds the demodulated signal to recover binary digital data.

The transport stream includes one or more digital television shows, programs, movies, or the like in the form of multiplexed digital data packets. Optionally, the demodulated digital multiplexed signal 84 is saved to a disk or other non-volatile medium in a step 88 using the recording device 62. Packets of the digital multiplexed signal 84 are sorted in a step 90 by the packet sorter 26 to extract one or more components of the selected audio/video offering. In the exemplary FIG. 2, four components are extracted: an audio/video component 92; and three application components 94, 96, 98.

In a step 100, the component identifier 30 reads a header packet of each component 92, 94, 96, 98 to identify the component. In the exemplary FIG. 2, three components are identified: the audio/video component 92 is identified as a game video 102; the application 94 is identified as a player statistics application 104, and the application 96 is identified as a commercials generating application 106. The component identifier 30 is unable to identify the third application component 98, perhaps because no identifying header file was provided, and so the application 98 is designated App #3 108. Although in the method 80 header packets were read to determine component identifications, it is also contemplated to read a table of contents optionally provided by the broadcaster 12 with the transport stream 84. Other techniques to identify components can also be used, such as comparison with an internal database of identifying features of commonly used applications, or reading an identifying portion of the application component Java code.

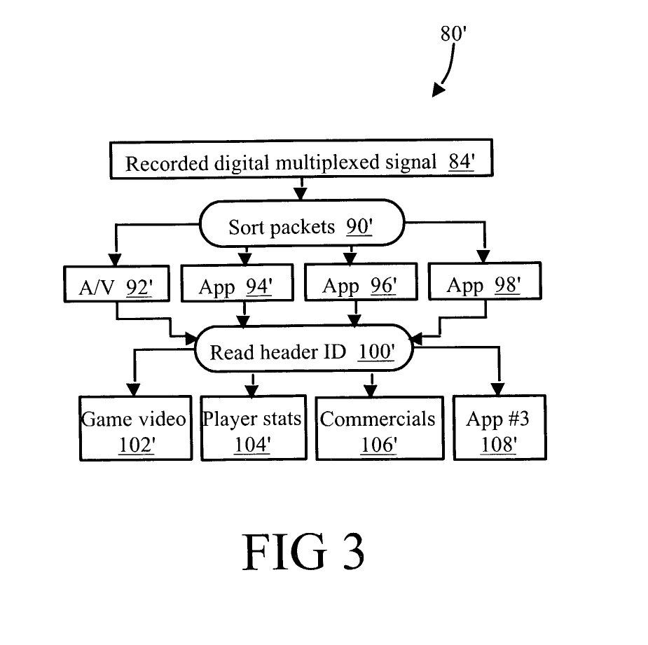

With continuing reference to FIG. 1 and with further reference to FIG. 3, a method 80′ analogous to the method 80 is performed by the satellite receiver box 18 to read one or more content components of a selected digital television show, program, movie, or other audio/video offering of a recorded digital multiplexed signal 84′ stored on a disk or other non-volatile storage medium accessed by the recording device 62. Typically, the signal 84′ includes an audio/video offering arranged in digital data packets with zero, one, or more supplemental content components arranged as digital data packets that are packet-multiplexed with the audio/video component.

Packets of the recorded digital multiplexed signal 84′ are sorted in a step 90′ by the packet sorter 26 to extract one or more components of the selected audio/video offering. In the exemplary FIG. 3, four components are extracted: an audio/video component 92′; and three application components 94′, 96′, 98′.

In a step 100′, the component identifier 30 reads a header packet of each component 92′, 94′, 96′, 98′ to identify the component. In the exemplary FIG. 3 three components are identified: the audio/video component 92′ is identified as a game video 102′; the application 94′ is identified as a player statistics application 104′, and the application 96′ is identified as a commercials generating application 106′. The component identifier 30 is unable to identify the third application component 98′, perhaps because no identifying header file was provided, and so the application 98′ is designated App #3 108′.

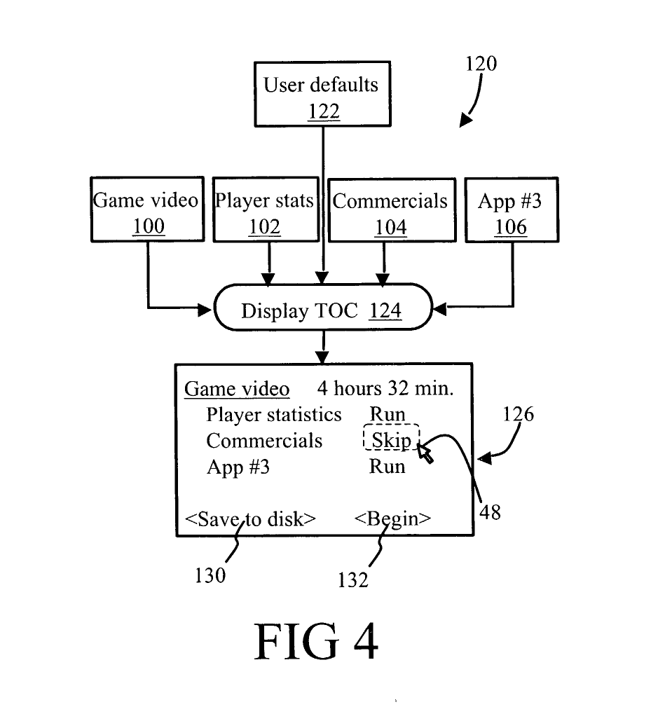

With continuing reference to FIG. 1 and with further reference to FIG. 4, a method 120 for selecting components of an audio/video offering to perform or save to disk is described. The exemplary components of FIG. 2, namely the game video 100, the player statistics application 102, the commercials application 104, and the unidentified application 106, are input along with a user defaults parameters database 122 to the electronic program guide interface 34 in a step 124. The electronic program guide interface cooperates with the user interface 40 to display a table of contents 126 of the selected audio/video offering on the display device 42.

The audio/video component 100 is indexed first in the table of contents display 126, preferably along with a running time (4 hours, 32 min. in the display 126). The applications 102, 104, 106 are indexed below the audio/video component information. Each application has an associated “Run/Skip” selection, which is initially set to one of “Run” or “Skip” based on contents of the user defaults parameters database 122. For example, the default value for all application components can be “Run”, or it can be “Skip”. Moreover, the default value can depend upon the type of audio/video component (e.g., a user might want application components enabled with sporting events to get statistics information, but disabled for all other audio/video component types). In yet another contemplated variation, the user defaults parameters database 122 contains defaults for certain commonly encountered application components. For example, the default for all Commercials components is suitably set to “Skip”.

In still yet another contemplated variation, a default language parameter value is included in the user defaults parameters database 122. For a sporting event, movie, or the like, a plurality of supplemental components each provide a sound track, commentator voice-over, or other supplemental audio in a different language, such as English, French, German, Spanish, or the like. Based upon the default language parameter value one of these supplemental audio components is assigned the default “Run” while the other supplemental audio components in other languages are assigned the default “Skip”. The user retains the option of selecting a different language.

Using the pointer 48 or another user input, the user optionally chooses to change one or more of the default settings. In exemplary FIG. 4, the defaults for all application components is “Run”, and the user selects to change the Commercials component 104 to “Skip”. The table of contents display 126 further includes operation selections such as <Save to disk> 130 and <Begin> 132, which select to save the selected components using the recording device 62, and to begin a performance via the user interface 40 including the selected components, respectively.

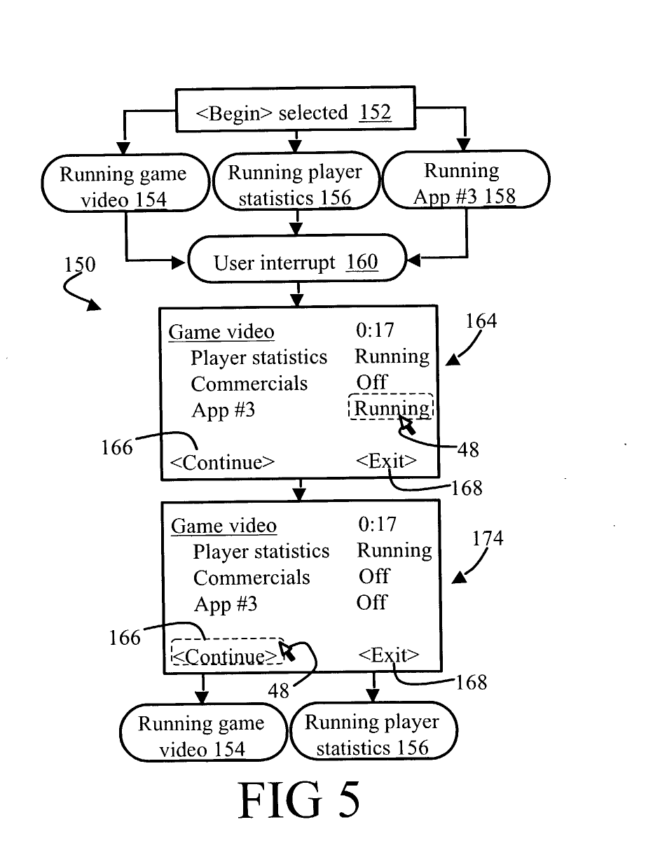

With continuing reference to FIG. 1 and with further reference to FIG. 5, a method 150 for performing the components selected in the method 120 of FIG. 4, and for modifying selections during the performing, is described. The <Begin> 132 selection is made in a step 152. This selection invokes the audio/video processor 50 to format streaming audio/video 154 that is sent to the user interface 40 for display on the display device 42, and also invokes the Java processor 58 to perform player statistics application execution 156 and App #3 execution 158. However, the user selected to skip the commercials application 104, and so it is not executed.

During performance of the selected components, the user may decide to change the component selections. For instance, in exemplary FIG. 5, the user finds that the unidentified App #3 106 is an undesirable application, such as a commercials display application or poor-quality game commentary from an incompetent announcer. Hence, in a step 160 the user selects an interrupt option, for example using one of the user input devices 44, 46.

In response to the user interrupt 160, an updated table of contents 164 is displayed. The table of contents 164 displays a current time index of the performance (in the display 164 this is 0:17, corresponding to 0 hours and 17 minutes into the performance) and the status of each supplemental content component: Player statistics is Running; Commercials is Off; and App #3 is Running. The Table of contents 164 also gives suitable operation selections such as <Continue> 166 and <Exit> 168.

In exemplary FIG. 5, the user selects to change the status of App #3 from Running to Off and moves to select <Continue> 166 to produce a further updated table of contents display 174. Upon user selection of <Continue>, the performance continues limited however to the audio/video component streaming 154 and Player statistics application execution 156. Of course, if the user instead selects <Exit> the performance is terminated.

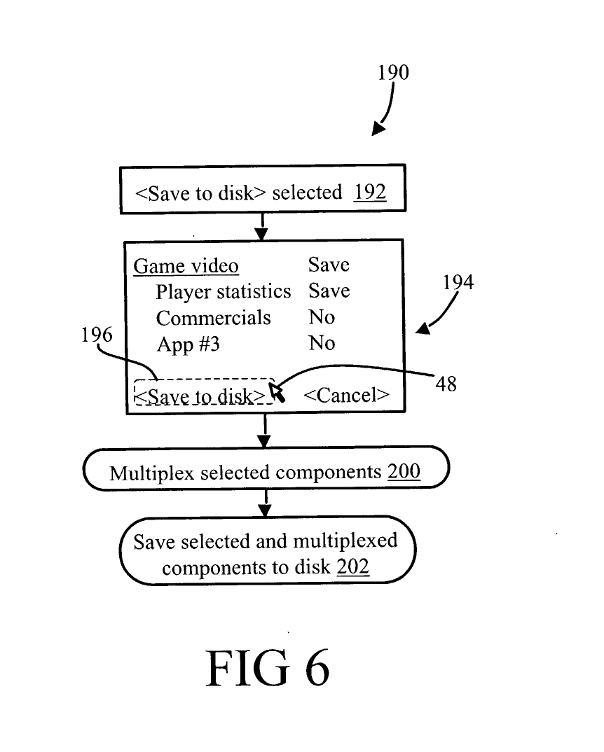

With continuing reference to FIG. 1, brief reference back to FIG. 4, and further reference to FIG. 6, a method 190 for saving the selected components to a disk or other non-volatile storage medium is described. The <Save to disk> selection 130 of FIG. 4 is selected in a step 192 of the method 190 of FIG. 5. In response, an updated table of contents 194 is displayed, in which each component of the audio/video offering is indexed along with a “Save/No” selection.

In the table of contents 194, the audio/video component (game video) has a “Save/No” option. This is provided because it is contemplated that the user may wish to save one or more supplemental components without saving the corresponding audio/video component. For example, this might be done if the user has a mechanism for integrating the supplemental component into another audio/video offering. However, optionally the audio/video component is automatically saved, in which case the “Save/No” selection for that component is preferably omitted.

When the user has made appropriate selections, such as the selections shown in the table of contents 194 to save the game video and the player statistics components but not the commercials component or the App #3 component, the user selects a <Save to disk> selection 196. These selections are suitably made using the pointing device 48. In response, the selected components are arranged in packets which are packet-multiplexed to produce a multiplexed data packet stream in a step 200. The multiplexed data packet stream is recorded to an optical disk or other non-volatile storage medium by the recording device 62 in a step 202.

The multiplexing step 200 is preferably performed to provide a stored audio/video offering which is in a similar format to the packet-multiplexed transport stream of the digital broadcast television signal 14. This advantageously allows for the method 80′ of FIG. 3 to recover the recorded components in a substantially similar manner to the real-time digital television broadcast audio/video offering recovery method 80 of FIG. 2. The multiplexed format also beneficially permits the audio/video offering performance to partially overlap playback of the recorded data packets. However, it is also contemplated to omit the multiplexing step 200 and to record the selected components sequentially or in another non-multiplexed format.

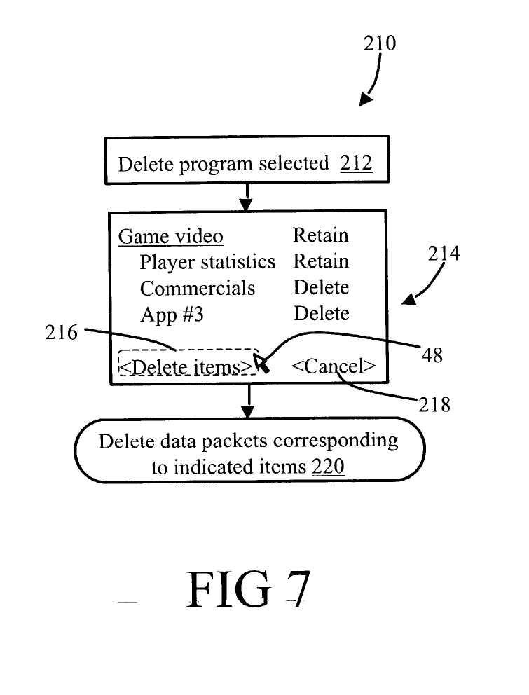

With reference to FIG. 7, a method 210 is preferably selectively executed by the satellite receiver box 18 and the recording device 62 to selectively delete one, several, or all recorded components of an audio/video offering. The method 210 is suitably selected, for example, to remove undesired components from a digital recording generated on another system which does not have selective component recording capability.

In a step 212, a delete program selection is made, which brings up an updated table of contents 214 which indexes the components of the exemplary game video offering. Each component includes a “Retain/Delete” selection. The game video and player statistics selections are indicated as “Retain”, meaning that they are not to be deleted, while the Commercials and App #3 selections are indicated as “Delete” indicating that these components should be deleted. The user suitably updates the selections for deletion using the pointer 48. The <Delete items> selection 216 is selected by the user (alternatively, the user can select the <Cancel> selection 218 to exit the table of contents 214 without deleting any components). Responsive to selection of the <Delete Items> selection 216, in a step 220 the recording device 62 deletes data packets corresponding to the selected components. Optionally, the data packets are not physically deleted, but rather the disk sectors or other allocation units corresponding to the selected components are marked as unused and available.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A digital television program processing method comprising:
sorting packets of a selected digital television program into an audio/video component and at least one supplemental component;
assigning component identifiers to the audio/video component and the at least one supplemental component;
displaying the component identifiers to an associated user;
receiving one or more selections of components to include in a performance of the offering; and
executing a selected operation using the selected components.

2. The digital television program processing method as set forth in claim 1, further including:
receiving a transport stream; and
selecting data packets of the transport stream associated with the selected digital television program.

3. The digital television program processing method as set forth in claim 2, wherein the step of receiving a transport stream includes:
receiving a digital television broadcast; and
demodulating a frequency channel of the broadcast which contains the transport stream.

4. The digital television program processing method as set forth in claim 3, wherein the step of assigning component identifiers includes:
retrieving the component identifiers from an electronic program guide included in the digital television broadcast.

5. The digital television program processing method as set forth in claim 2, wherein the step of receiving a transport stream includes:
receiving the transport stream from a recording medium.

6. The digital television program processing method as set forth in claim 1, wherein the step of assigning component identifiers includes:
reading a component identifier from a header packet of the component.

7. The digital television program processing method as set forth in claim 1, wherein the step of executing a selected operation using the selected components includes:
performing the digital television program, the performing including performing the selected components while omitting performance of the other components of the digital television program.

8. The digital television program processing method as set forth in claim 7, further including:
during the performing step, receiving an interrupt;
receiving one or more changes to the selections of components; and
continuing the performing step by performing the updated selection of components.

9. The digital television program processing method as set forth in claim 1, wherein the step of executing a selected operation using the selected components includes:
recording the digital television program to a non-volatile medium, the recording including recording the selected components while omitting recording of the other components of the digital television program.

10. The digital television program processing method as set forth in claim 9, further including:
multiplexing packets of the selected components, the multiplexed packet stream being recorded in the recording step.

11. The digital television program processing method as set forth in claim 1, wherein the digital television program resides on a non-volatile storage medium and the step of executing a selected operation using the selected components includes:
deleting the selected components from the non-volatile storage medium while retaining the other components of the digital television program on the non-volatile storage medium.

12. The digital television program processing method as set forth in claim 11, wherein the digital television program residing on the non-volatile medium is stored in a packet-multiplexed format, the deleting step including:
deleting packets corresponding to the selected components without affecting packets corresponding to the other components of the digital television program.

13. The digital television program processing method as set forth in claim 1, wherein the digital television program is a multiplexed program in which packets corresponding to the components are multiplexed, and the sorting step includes:
demultiplexing the packets into the audio/video component and the one or more supplemental components.

14. The digital television program processing method as set forth in claim 1, further including:
prior to the sorting step, receiving the digital television program from a frequency modulated television broadcast.

15. The digital television program processing method as set forth in claim 14, wherein the receiving step includes:
frequency demodulating the frequency modulated television broadcast to recover the digital television program.

16. A digital television receiving apparatus comprising:
a sorting means for sorting packets of a selected digital television program into an audio/video component and at least one supplemental component;
an assigning means for assigning component identifiers to the audio/video component and the at least one supplemental component;
a display means for displaying the component identifiers to an associated user;
a user input means for receiving one or more selections of components to include in a performance of the offering; and
an execution means for executing a selected operation using the selected components.

17. The digital television receiving apparatus as set forth in claim 16, further including:
a frequency demodulator that demodulates a selected frequency channel of a digital television transmission to extract a transport stream of digital data packets; and
a program selection means for selecting digital data packets associated with the selected digital television program.

18. The digital television receiving apparatus as set forth in claim 17, wherein the assigning means includes:
an electronic program guide interface that receives an electronic program guide from the demodulated frequency channel, the electronic program guide including component identifiers corresponding to the audio/video component and the at least one supplemental component.

19. The digital television receiving apparatus as set forth in claim 17, wherein the transport stream of digital data packets is arranged in a multimedia home platform (MHP) format.

20. The digital television receiving apparatus as set forth in claim 16, wherein the execution means includes:
a recording means for selectively recording the selected components.

21. The digital television receiving apparatus as set forth in claim 16, further including:
a user defaults database containing user default parameters for assigning one of a default selection or a default non-selection to each supplemental component.

22. The digital television receiving apparatus as set forth in claim 16, wherein the execution means includes:
an audio/video processor that formats streaming audio/video; and
a microprocessor-based computational device for executing the selected supplemental components.

23. The digital television receiving apparatus as set forth in claim 22, wherein the microprocessor-based computational device is a Java processor.
